(19) United States
(12) Patent Application Publication
(10) Pub. No.: US 2024/0359633 A1
(43) Pub. Date: Oct. 31, 2024

(54) HITCH ADAPTER WITH WHEELED SKID PLATE AND METHOD

(71) Applicant: Alan Taylor, Myakka City, FL (US)

(72) Inventor: Alan Taylor, Myakka City, FL (US)

(21) Appl. No.: 18/650,035

(22) Filed: Apr. 29, 2024

Related U.S. Application Data
(60) Provisional application No. 63/462,469, filed on Apr. 27, 2023.

(51) Int. Cl. B60R 9/06

(52) U.S. Cl. CPC B60R 9/06

(57) ABSTRACT

A hitch adapter with a wheeled skid plate is described. In some examples, a hitch adapter can include a hitch adapter tube, wherein the hitch adapter tube is attached to the hitch adapter, one or more crossmember tubes, wherein one or more of the one or more crossmember tubes extend from the hitch adapter tube, one or more interconnect tubes, wherein one or more of the one or more interconnect tubes connect one or more of the one or more crossmember tubes, and a skid wheel, wherein the skid wheel is attached to one of the one or more interconnect tubes.

### CROSS-REFERENCE TO RELATED APPLICATIONS

This application claims the priority of Provisional Application No. 63/462,469 filed on Apr. 27, 2023. The content of the provisional application is incorporated herein by reference in its entirety.

### FIELD

Some implementations relate generally to hitch adapters, and more particularly, to a hitch adapter with a wheeled skid plate.

### BACKGROUND

Some existing hitch adapters may not distribute vehicle weight and vehicle contact force adequately. Such existing hitch adapters may result in, for example, vehicle chassis dragging on steep surfaces due to inadequate rolling contact between the vehicle chassis and a steep surface.

It may therefore be desirable to provide a new and improved hitch adapter that helps prevent vehicle chassis drag on steep surfaces by providing adequate rolling contact between the vehicle chassis and a steep surface and redistributing the contact force (corresponding to the contact of the vehicle chassis with the surface) via a weight/force distribution framework. This arrangement can, for example, reduce vehicle chassis drag. Some implementations were conceived in light of the above-mentioned limitations, needs, or problems, among other things.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Some implementations include a hitch adapter with a wheeled skid plate. The hitch adapter can include a skid plate. The hitch adapter can also include one or more wheels.

In some implementations, a hitch adapter comprises: a hitch adapter tube, wherein the hitch adapter tube can be attached to the hitch adapter, one or more crossmember tubes, wherein the one or more crossmember tubes can extend from the hitch adapter tube; one or more interconnect tubes, wherein one or more of the one or more interconnect tubes can connect one or more of the one or more crossmember tubes; a skid wheel, wherein the skid wheel can be attached to one or more of the one or more interconnect tubes. The hitch adapter tube can comprise a proximal end and a distal end in some implementations. The hitch adapter tube can be a 2-inch square receiver mount in some implementations. In some implementations, the one or more interconnect tubes can comprise a left interconnect tube and a right interconnect tube. In some implementations, the left interconnect tube can be located towards a left side of a proximal end of the hitch adapter tube. In some implementations, the right interconnect tube can be located towards a right side of a proximal end of the hitch adapter tube. The skid wheel can be attached below the one or more of the one or more interconnect tubes in some implementations.

In some implementations, the hitch adapter tube, at least one of the one or more crossmember tubes, and at least one of the one or more interconnect tubes form a skid plate. In some implementations, the skid plate can take the form of a polygonal shape, an oval shape, or a circular shape. In some implementations, the hitch adapter tube, at least one of the one or more crossmember tubes, and at least one of the one or more interconnect tubes can comprise one or more of one or more indentations, one or more cutouts, or one or more apertures. In some implementations, the hitch adapter tube and at least one of the one or more crossmember tubes can be connected using one or more support brackets. In some implementations, at least one of the one or more crossmember tubes and at least one of the one or more interconnect tubes can be connected through one or more support brackets. In some implementations, at least one of the hitch adapter tubes, at least one of the one or more crossmember tubes, and at least one of the one or more interconnect tubes can be attached to one or more endcaps, e.g., to close end openings. In some implementations, the hitch adapter can be made of one or more of steel, aluminum, fiberglass, carbon, rubber, polymer, plastic, a natural material, a synthetic material, or a composite material.

In some implementations, a hitch adapter comprises: a hitch adapter tube, wherein the hitch adapter tube can be attached to the hitch adapter, and wherein the hitch adapter tube can comprise a proximal end and a distal end; a first brace tube and a second brace tube, wherein the first brace tube and the second brace tube can each be attached to the proximal end of the hitch adapter tube and one of the one or more crossmember tubes; one or more crossmember tubes, wherein the one or more crossmember tubes can extend from the hitch adapter tube; one or more interconnect tubes, wherein one or more of the one or more interconnect tubes can connect one or more of the one or more crossmember tubes; a skid wheel, wherein the skid wheel can be attached to one of the one or more interconnect tubes. In some implementations, the first brace tube and the second brace tube can be bolted to the hitch adapter tube. In some implementations, the first brace tube and the second brace tube can be welded to the hitch adapter tube.

In some implementations, the skid wheel can be attached below the one or more of the one or more interconnect tubes. In some implementations, the hitch adapter tube can be a 2-inch square receiver mount. In some implementations, the hitch adapter can be made of one or more of steel, aluminum, fiberglass, carbon, rubber, polymer, plastic, a natural material, a synthetic material, or a composite material.

### BRIEF DESCRIPTION OF THE DRAWINGS

FIG. 1 is a diagram showing an isometric view of an example hitch adapter in accordance with some implementations.

FIG. 2 is a diagram showing a top view of an example hitch adapter in accordance with some implementations.

FIG. 3 is a diagram showing a left side view of an example hitch adapter in accordance with some implementations.

FIG. 4 is a diagram showing a front view of an example hitch adapter in accordance with some implementations.

FIG. 5 is a diagram showing a right-side view of an example hitch adapter in accordance with some implementations.

FIG. 6 is a diagram showing a bottom view of an example hitch adapter in accordance with some implementations.

FIG. 7 is a diagram showing a rear view of an example hitch adapter in accordance with some implementations.

FIG. 8 is a diagram showing an isometric view of an example hitch adapter in accordance with some implementations.

FIG. 9 is a diagram showing a top view of an example hitch adapter in accordance with some implementations.

FIG. 10 is a diagram showing a left side view of an example hitch adapter in accordance with some implementations.

FIG. 11 is a diagram showing a front view of an example hitch adapter in accordance with some implementations.

FIG. 12 is a diagram showing a right-side view of an example hitch adapter in accordance with some implementations.

FIG. 13 is a diagram showing a bottom view of an example hitch adapter in accordance with some implementations.

FIG. 14 is a diagram showing a rear view of an example hitch adapter in accordance with some implementations.

FIG. 15 is a diagram showing views of a main tube and an interconnect tube in accordance with some implementations.

FIG. 16 is a diagram showing an isometric view of a main tube in accordance with some implementations.

FIG. 17 is a diagram showing an isometric view of a main tube in accordance with some implementations.

FIG. 18 is a diagram showing an isometric view of a wheeled interconnect tube in accordance with some implementations.

FIG. 19 is a diagram showing an isometric view of a wheeled interconnect tube in accordance with some implementations.

FIG. 20 is a diagram showing views of a main tube and an interconnect tube in accordance with some implementations.

FIG. 21 is a diagram showing an isometric view of a main tube in accordance with some implementations.

FIG. 22 is a diagram showing an isometric view of a main tube in accordance with some implementations.

FIG. 23 is a diagram showing an isometric view of a wheeled interconnect tube in accordance with some implementations.

FIG. 24 is a diagram showing an isometric view of a wheeled interconnect tube in accordance with some implementations.

FIG. 25 is a diagram showing a hitch adapter with a wheeled skid plate attached to a vehicle chassis in accordance with some implementations.

FIG. 26 is a diagram showing a hitch adapter with a wheeled skid plate attached to a vehicle chassis in accordance with some implementations.

FIG. 27 is a diagram showing a hitch adapter with a wheeled skid plate attached to a vehicle chassis in accordance with some implementations.

FIG. 28 is a diagram showing a hitch adapter with a wheeled skid plate attached to a vehicle chassis in accordance with some implementations.

### DETAILED DESCRIPTION

A hitch adapter with a wheeled skid plate can include at least a main tube (which further includes a hitch adapter functionality), interconnect tubes, crossmember tubes, and a wheel for providing a rolling point of contact for the adapter. The hitch adapter can be attached to a vehicle frame/chassis under the rear of a vehicle. Such example hitch adapters with a wheeled skid plate can, for example, be used with vehicles such as recreation campers, trailers, and utility vehicles.

In some implementations, a hitch adapter with a wheeled skid plate comprises a main tube, also referred to herein as the hitch adapter tube. The hitch adapter tube can have a proximal end and a distal end, wherein the proximal end of the hitch adapter tube, i.e., the main tube, is the end furthest away from the front end of the vehicle. The proximal end of the hitch adapter tube can be sized as a receiver for accepting standard and/or custom-made attachments (for example, without limitation, attachments from trailers or utility accessories). The proximal end of the hitch adapter tube can be configured as an adapter that mates with a vehicle's existing hitch assembly (for example, without limitation, a tow hitch). The proximal end and the distal end of the hitch adapter tube, i.e., the main tube, can further include a capping device to enclose open tubing in the hitch adapter tube and/or adapt the proximal end to an apparatus that is attached to that end.

In some implementations, the crossmember tubes extend from the hitch adapter tube, i.e., the main tube. In some implementations, the crossmember tubes are connected to each other using the interconnect tubes. In some implementations, the interconnect tubes can include a left interconnect tube (left of the proximal end of the main tube) and a right interconnect tube (right of the proximal end of the main tube). The left and right interconnect tubes are referred to herein as the interconnect tubes, unless a distinction between left and right is needed in a particular context. In some implementations, at least one skid wheel is attached to at least one interconnect tube. In some implementations, a skid wheel is attached to the underside an interconnect tube or tubes. Skid wheels can absorb the impact generated by a vehicle chassis striking the ground. Skid wheels can also make a rolling contact between the vehicle chassis and the ground, thus limiting or even preventing the impact generated when the vehicle chassis strikes the ground. Skid wheels can also reduce damage caused by the drag that arises when the vehicle chassis strikes the ground. Such damage can occur in the absence of the rolling contact made by the skid wheels.

In some implementations, at least one crossmember tube and its adjacent interconnect tube form a skid plate in conjunction with the hitch adapter tube, i.e., the main tube. The main tube, the crossmember tubes, and the interconnect tubes can be combined in various shapes and/or sizes to form different sized or varied shaped skid plates. By changing the configuration of the hitch adapter tube, i.e., the main tube, the crossmember tubes, and the interconnect tubes, the skid plate can provide different force and weight distributions patterns. Therefore, the skid plate can be customized to support a specific vehicle and/or a specified vehicle environment.

In some implementations, the hitch adapter tube (i.e., the main tube), one or more of the interconnect tubes, and one or more of the crossmember tubes can include indentations, cut-outs, or apertures to compliment the chassis of a vehicle to which the hitch adapter with a wheeled skid plate is attached. In some implementations, an outer plate can be attached (for example, via bolts) to each interconnect tube. In some implementations, the outer plates can be used to help attach the hitch adapter with a wheeled skid plate to the vehicle chassis. The outer plates can be bolted to the vehicle chassis or to the undercarriage of the vehicle in some implementations. The outer plates can also be welded to the vehicle chassis or to the undercarriage of the vehicle in some implementations. In some implementations, the outer plates can be pre-selected to interface with a specified vehicle chassis. For example, outer plates with a desired configuration of holes suitable for attachment to a selected vehicle chassis can be pre-selected. In addition, holes can be drilled into the vehicle chassis to align with the holes of an existing or off-the-shelf outer plate.

In some implementations, custom adapter plates and/or shims can be used with the hitch adapter tube (i.e., the main tube), one or more crossmember tubes, one or more outer plates, one or more interconnect tubes, and/or one or more wheels to align the relevant components of the hitch adapter with a wheeled skid plate with the vehicle to which the hitch adapted is attached. In some implementations, support brackets are provided to enable the hitch adapter tube (i.e., the main tube), one or more crossmember tubes, and/or one or more interconnect tubes to be connected or joined together. In some implementations, a pre-selected or pre-specified combination of adapter plates, shims, and/or support brackets are provided for specified vehicles. In some implementations, the hitch adapter tube (i.e., the main tube), one or more crossmember tubes, and/or one or more interconnect tubes can be capped with an endcap (to close openings).

In some implementations, interconnections of the hitch adapter tube (i.e., the main tube), one or more crossmember tubes, one or more outer plates, one or more interconnect tubes, and/or one or more wheels form a weight and/or force distribution framework. In some implementations, the weight and/or force distribution framework transfers forces from the hitch adapter tube (i.e., the main tube) across one or more crossmember tubes and one or more interconnect tubes, thereby enhancing the ability of the hitch adapter with a wheeled skid plate to support the weight and the forces of accessories attached to a receiver mount connected to the hitch adapter tube. In some implementations, the weight and/or force distribution framework transfers the rolling contact (for example, the contact made when one or more wheels contact a surface) and distributes the rolling contact among one or more interconnections to minimize or even prevent damage to the vehicle chassis and/or to the undercarriage of the vehicle. In some implementations, the weight and/or force distribution framework distributes the rolling contact among a preconfigured interconnected framework, where elements of the framework can include one or more of the hitch adapter tube (i.e., the main tube), one or more crossmember tubes, one or more outer plates, one or more interconnect tubes, and/or one or more wheels, among other elements. In some implementations, the weight and/or force distribution framework forms a structure for distributing weight and/or force from objects attached to the hitch adapter tube, for example, trailers, boat mounts, bike mounts, storage racks, custom carriers, accessories, and/or other items/objects attached to the proximal end of the hitch adapter tube (i.e., the main tube).

In some implementations the hitch adapter with a wheeled skid plate includes a pair of brace tubes attached between the hitch adapter tube (i.e., the main tube) at its proximal end and one or more crossmember tubes. In some implementations, the brace tubes are bolted to the hitch adapter tube (i.e., the main tube) and the crossmember tubes. In some implementations, the brace tubes are welded to the hitch adapter tube (i.e., the main tube) and the crossmember tubes. In some implementations, the hitch adapter with a wheel skid plate and the pair of brace tubes is designed to be attached to vehicles with a chassis and/or an undercarriage with limited space.

In some implementations, the hitch adapter with a wheeled skid plate can be attached to the vehicle chassis below the rear bumper. In some implementations, the left and the right interconnect tubes are attached to the vehicle chassis (for example, via welds or bolts). In some implementations, the hitch adapter tube (i.e., the main tube) and one or more crossmember tubes are attached to one or more of the left and the right interconnect tubes. In some implementations, a receiver mount is attached to the hitch adapter tube. In some implementations, the hitch adapter with a wheeled skid plate can be attached to a camper along with an accessory mount. In some implementations, the accessory mounted onto the camper can carry objects such as bicycles.

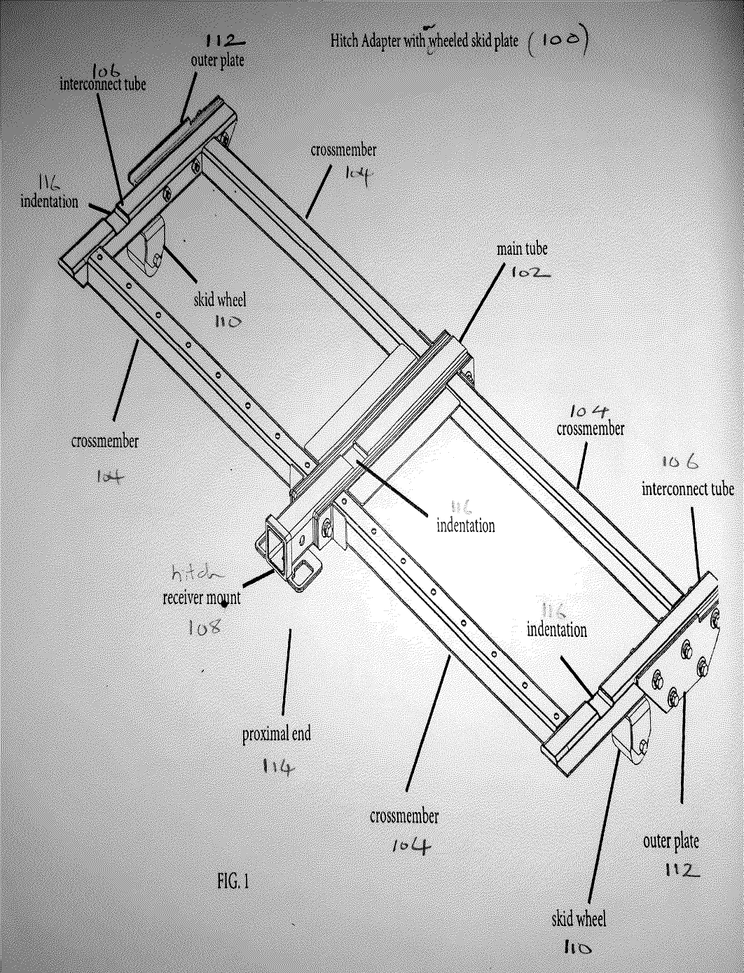

The present disclosure will be better understood and objects, other than those set forth above, will become apparent when consideration is given to the following detailed description of the present disclosure. The below description refers to the annexed drawings, i.e., FIGS. 1-28. FIGS. 1-28 show diagrams of an example hitch adapter (e.g., 100) and/or components thereof.

FIG. 1 is a diagram showing an isometric view of an example hitch adapter 100 in accordance with some implementations. More specifically, FIG. 1 shows a main tube 102 (also referred to herein as a hitch adapter tube), a plurality of crossmembers 104, a plurality of interconnect tubes 106, a hitch receiver mount 108, at least two skid wheels 110, at least two outer plates 112, a proximal end 114 of the main tube 102, and a plurality of indentations 116.

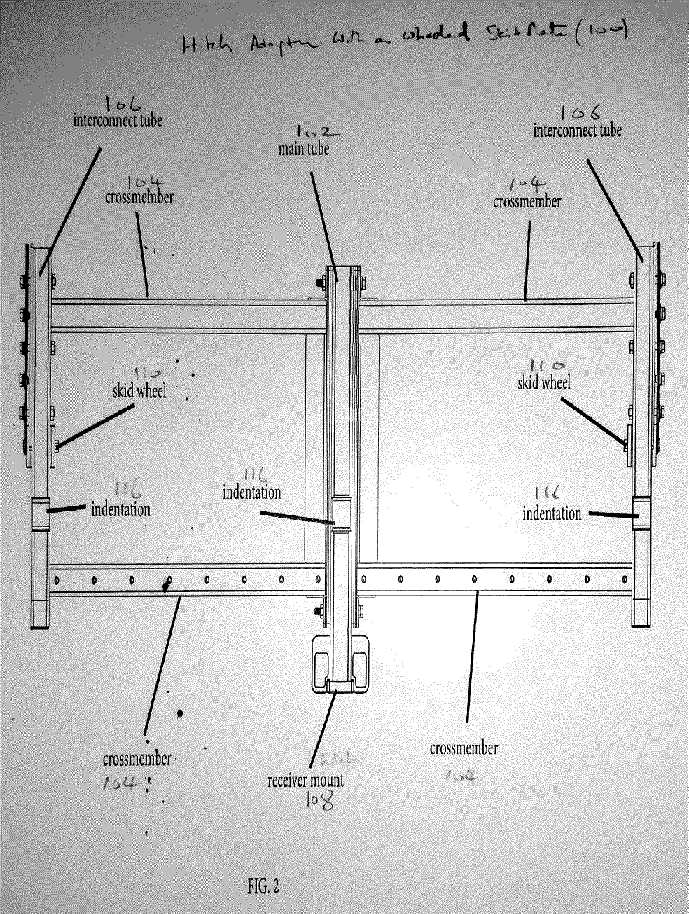

FIG. 2 is a diagram showing a top view of an example hitch adapter 100 in accordance with some implementations. More specifically, FIG. 2 shows the main tube 102 (also referred to herein as a hitch adapter tube), a plurality of crossmembers 104, a plurality of interconnect tubes 106, the hitch receiver mount 108, two skid wheels 110, and a plurality of indentations 116.

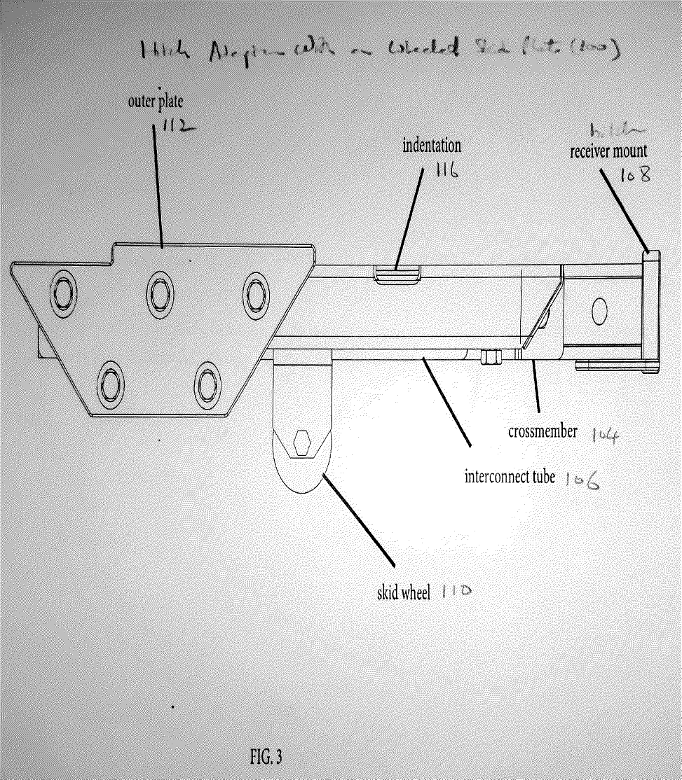

FIG. 3 is a diagram showing a left side view of an example hitch adapter 100 in accordance with some implementations. More specifically, FIG. 3 shows an outer plate 112, a crossmember 104, an interconnect tube 106, the hitch receiver mount 108, a skid wheel 110, and an indentation 116.

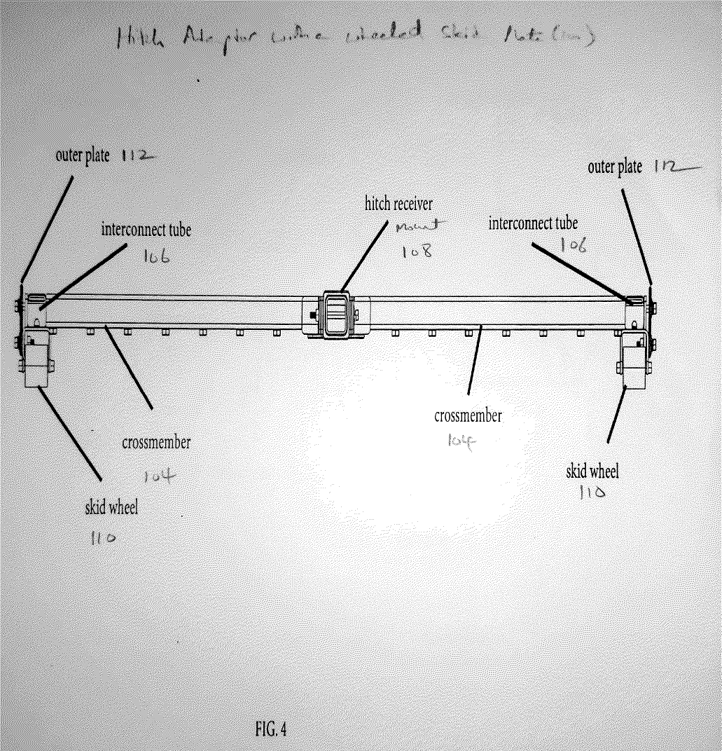

FIG. 4 is a diagram showing a front view of an example hitch adapter 100 in accordance with some implementations. More specifically, FIG. 4 shows two outer plates 112, two crossmembers 104, two interconnect tubes 106, the hitch receiver mount 108, and two skid wheels 110.

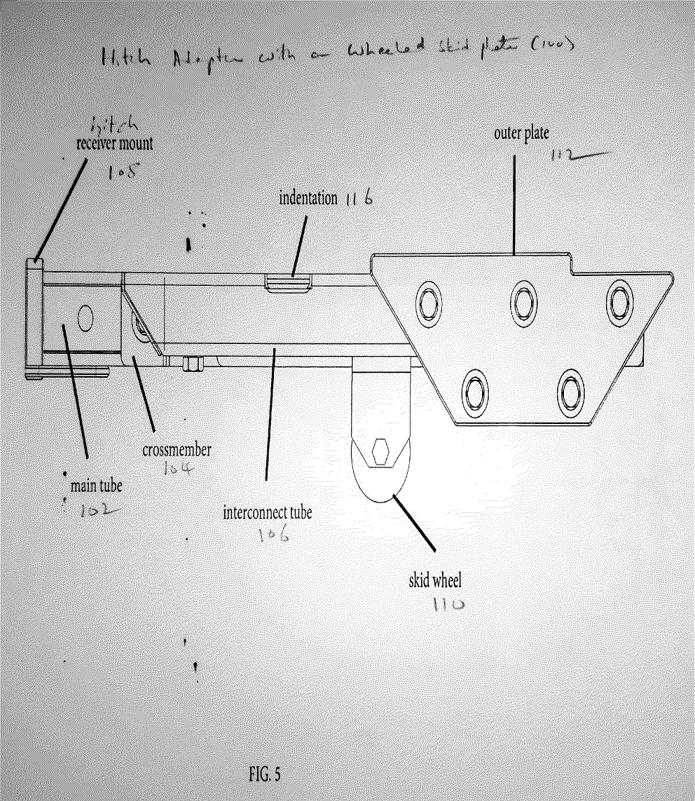

FIG. 5 is a diagram showing a right-side view of an example hitch adapter 100 in accordance with some implementations. More specifically, FIG. 5 shows an outer plate 112, a crossmember 104, an interconnect tube 106, the hitch receiver mount 108, a skid wheel 110, the main tube 102 (also referred to herein as a hitch adapter tube), and an indentation 116.

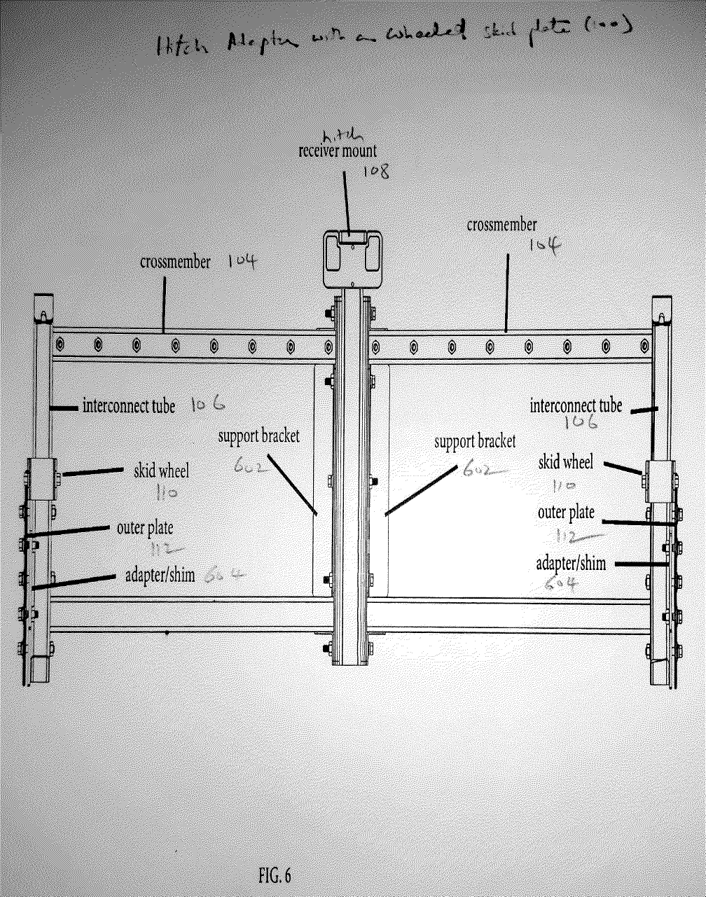

FIG. 6 is a diagram showing a bottom view of an example hitch adapter 100 in accordance with some implementations. More specifically, FIG. 6 shows a plurality of crossmembers 104, a plurality of interconnect tubes 106, the hitch receiver mount 108, two skid wheels 110, two outer plates 112, two support brackets 602 for connecting one or more crossmembers 104 with one or more interconnect tubes 106, and at least two adapters/shims 604 on the interconnect tubes 106.

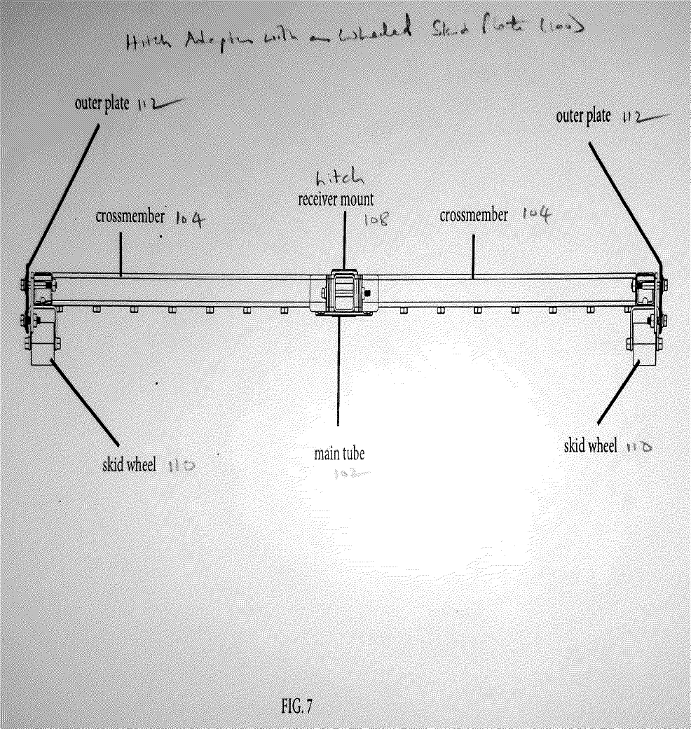

FIG. 7 is a diagram showing a rear view of an example hitch adapter 100 in accordance with some implementations. More specifically, FIG. 7 shows two outer plates 112, two crossmembers 104, the hitch receiver mount 108, the main tube 102 (also referred to herein as a hitch adapter tube), and two skid wheels 110.

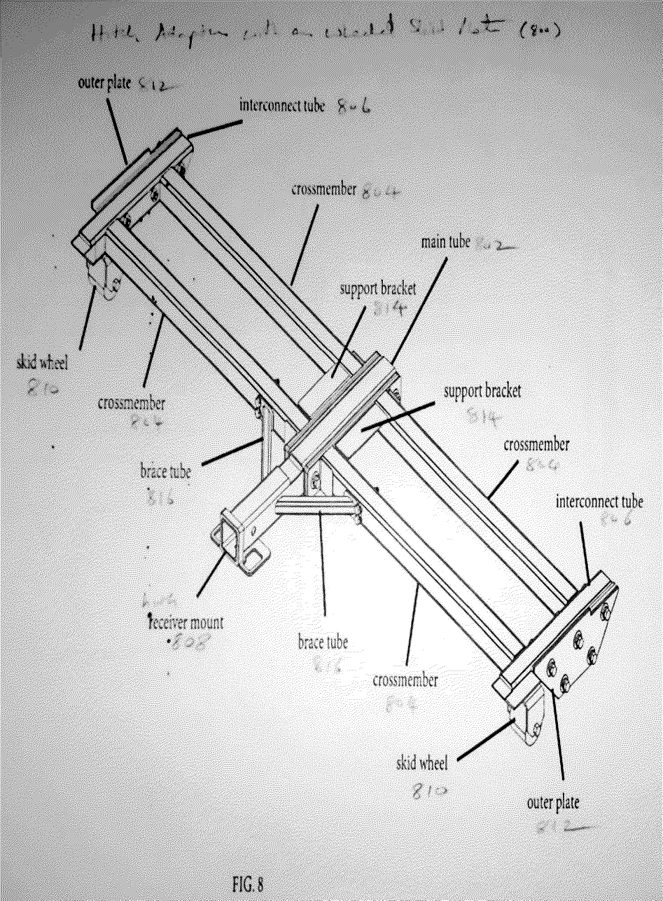

FIG. 8 is a diagram showing an isometric view of an example hitch adapter 800 in accordance with some implementations. More specifically, FIG. 8 shows a main tube 802 (also referred to herein as a hitch adapter tube), a plurality of crossmembers 804, a plurality of interconnect tubes 806, a hitch receiver mount 808, at least two skid wheels 810, at least two outer plates 812, at least two support brackets 814, and at least two brace tubes 816.

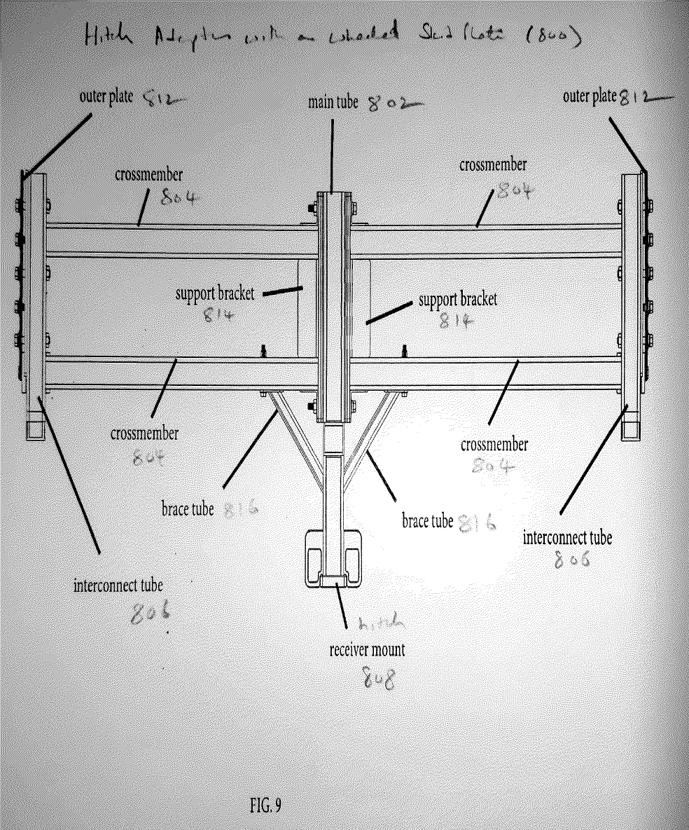

FIG. 9 is a diagram showing a top view of an example hitch adapter 800 in accordance with some implementations. More specifically, FIG. 9 shows the main tube 802 (also referred to herein as a hitch adapter tube), a plurality of crossmembers 804, a plurality of interconnect tubes 806, the hitch receiver mount 808, outer plates 812, support brackets 814, and brace tubes 816.

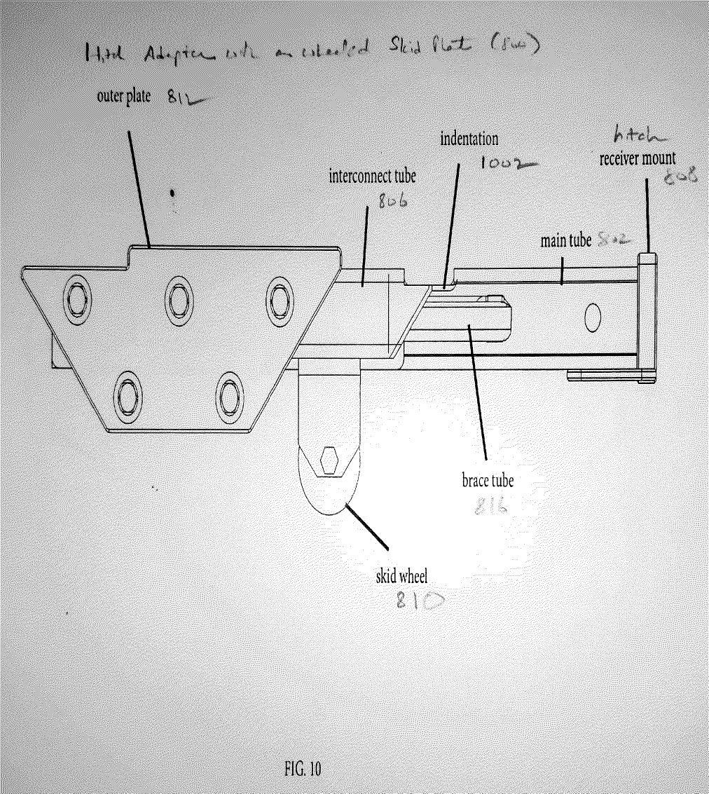

FIG. 10 is a diagram showing a left side view of an example hitch adapter 800 in accordance with some implementations. More specifically, FIG. 10 shows an outer plate 812, an interconnect tube 806, the hitch receiver mount 808, a skid wheel 810, a brace tube 816, the main tube 802 (also referred to herein as a hitch adapter tube), and an indentation 1002.

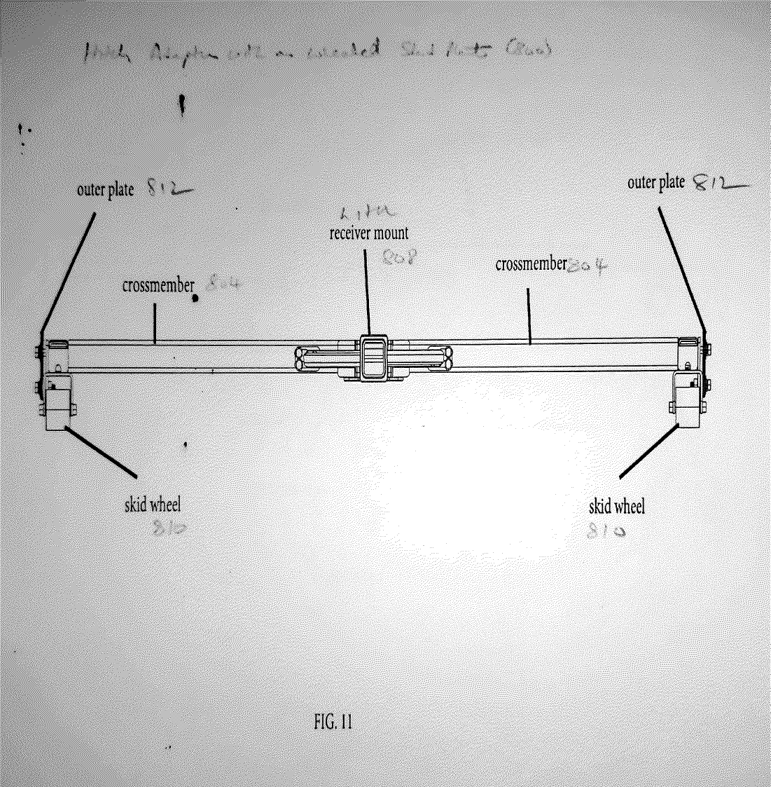

FIG. 11 is a diagram showing a front view of an example hitch adapter 800 in accordance with some implementations. More specifically, FIG. 11 shows two outer plates 812, two crossmembers 804, the hitch receiver mount 808, and two skid wheels 810.

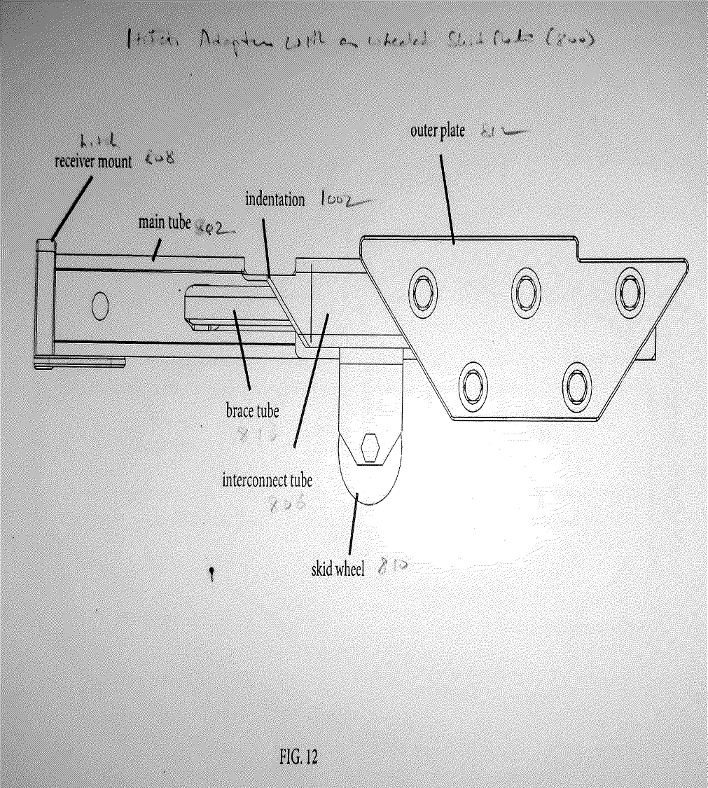

FIG. 12 is a diagram showing a right-side view of an example hitch adapter 800 in accordance with some implementations. More specifically, FIG. 12 shows an outer plate 812, an interconnect tube 806, the hitch receiver mount 808, a skid wheel 810, the main tube 802 (also referred to herein as a hitch adapter tube), a brace tube 816, and an indentation 1002.

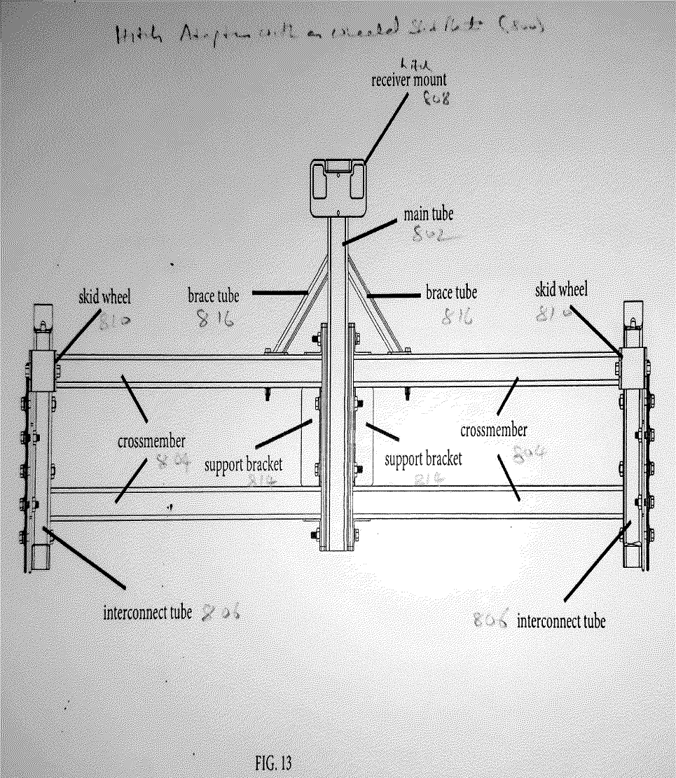

FIG. 13 is a diagram showing a bottom view of an example hitch adapter 800 in accordance with some implementations. More specifically, FIG. 13 shows a plurality of crossmembers 804, a plurality of interconnect tubes 806, the hitch receiver mount 808, two skid wheels 810, two support brackets 814 for connecting one or more crossmembers with one or more interconnect tubes, two brace tubes 816, and the main tube 802 (also referred to herein as a hitch adapter tube).

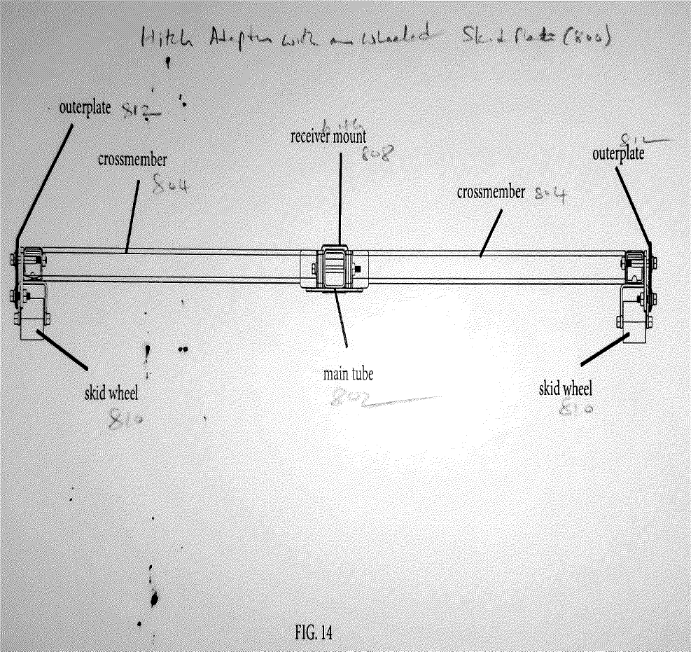

FIG. 14 is a diagram showing a rear view of an example hitch adapter 800 in accordance with some implementations. More specifically, FIG. 14 shows two outer plates 812, two crossmembers 804, the hitch receiver mount 808, the main tube 802 (also referred to herein as a hitch adapter tube), and two skid wheels 810.

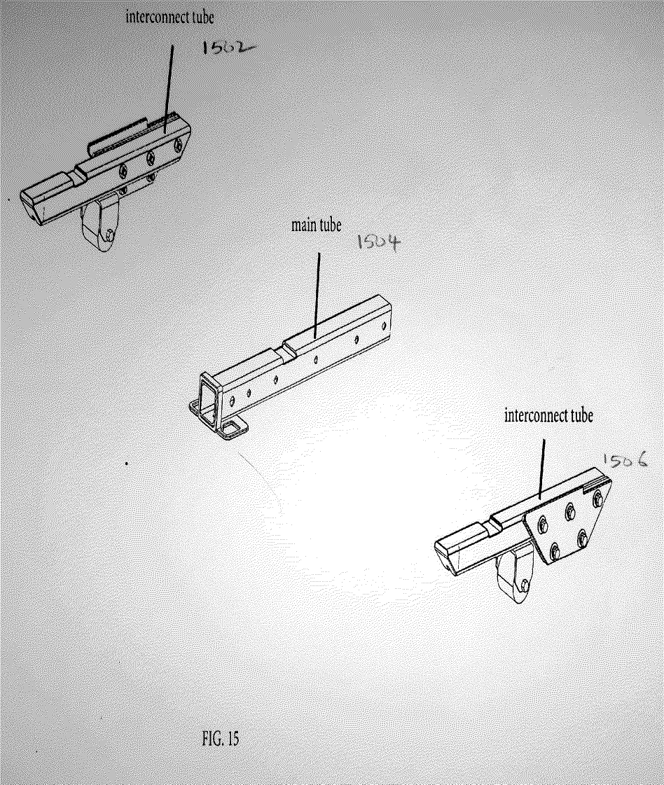

FIG. 15 is a diagram showing views of a main tube and an interconnect tube in accordance with some implementations. More specifically, FIG. 15 shows a first view 1502 and a second view 1506 of the interconnect tube and a single view 1504 of the main tube.

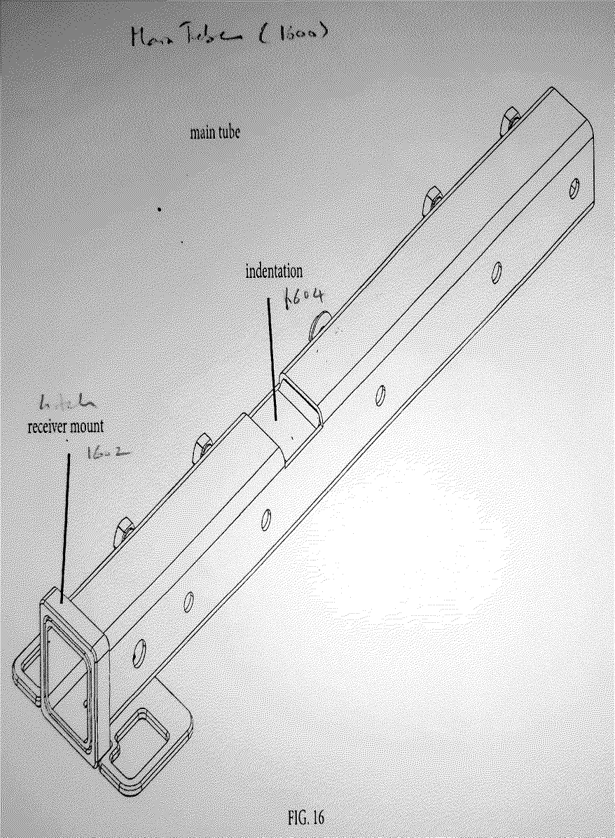

FIG. 16 is a diagram showing an isometric view of a main tube in accordance with some implementations. More specifically, FIG. 16 shows a view of the main tube 1600 (also referred to here as a hitch adapter tube) that includes a hitch receiver mount 1602 and an indentation 1604.

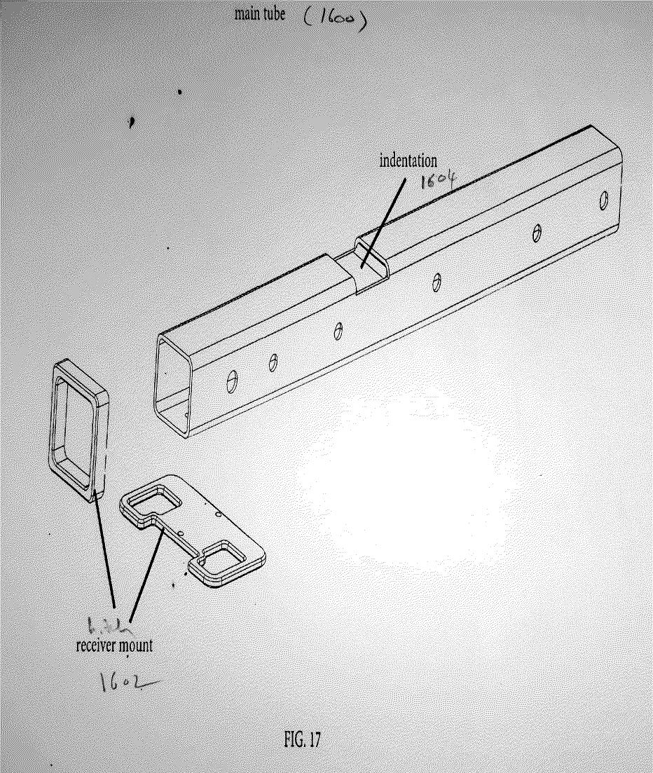

FIG. 17 is a diagram showing an isometric view of a main tube in accordance with some implementations. More specifically, FIG. 17 shows a view of the main tube 1600 (also referred to here as a hitch adapter tube) that includes a hitch receiver mount 1602 and an indentation 1604.

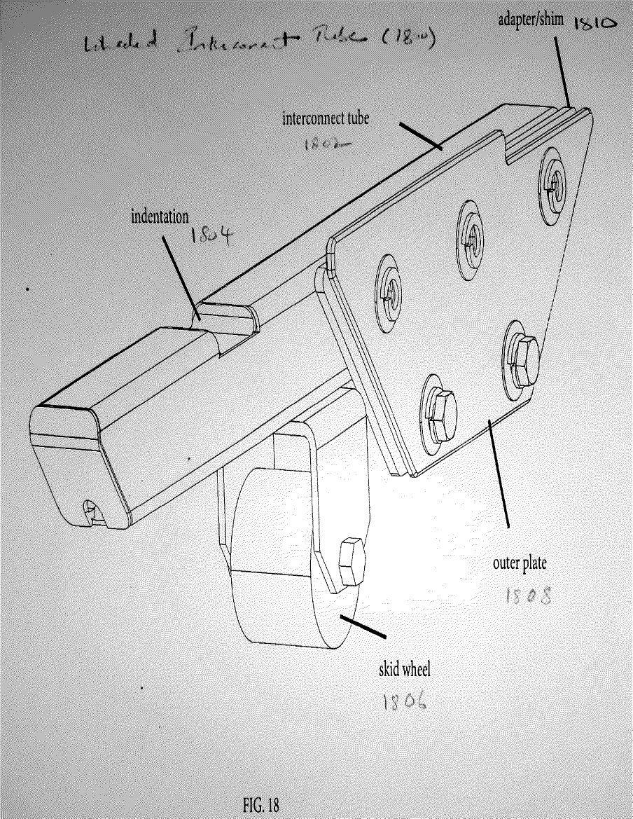

FIG. 18 is a diagram showing an isometric view of a wheeled interconnect tube in accordance with some implementations. More specifically, FIG. 18 shows an interconnect tube 1802, an indentation 1804 on the interconnect tube 1802, a skid wheel 1806, an outer plate 1808, and an adapter/shim 1810 that is bolted to the interconnect tube 1802 using the outer plate 1808.

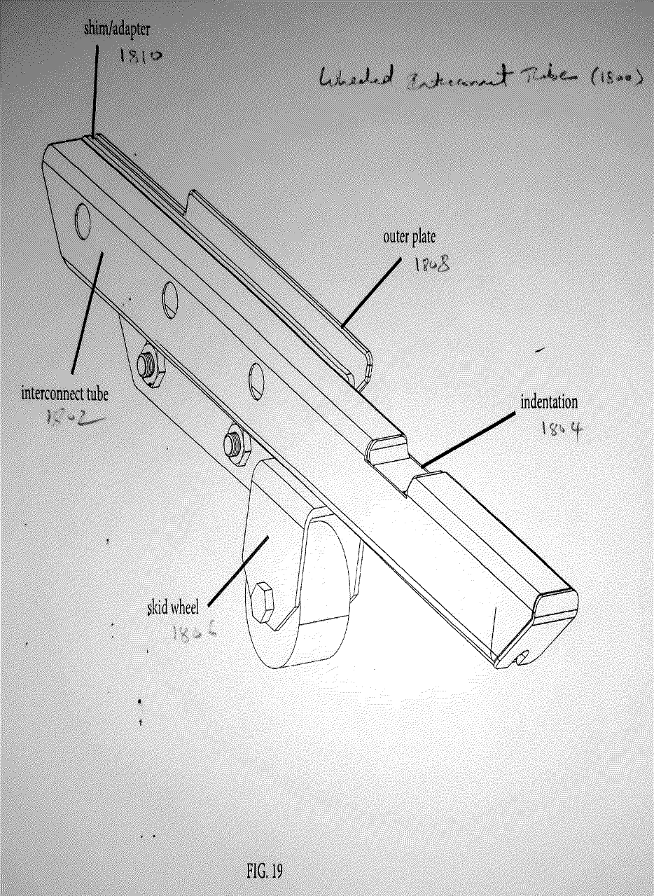

FIG. 19 is a diagram showing an isometric view of a wheeled interconnect tube in accordance with some implementations. More specifically, FIG. 19 shows an interconnect tube 1802, an indentation 1804 on the interconnect tube 1802, a skid wheel 1806, an outer plate 1808, and an adapter/shim 1810 that is bolted to the interconnect tube 1802 using the outer plate 1808.

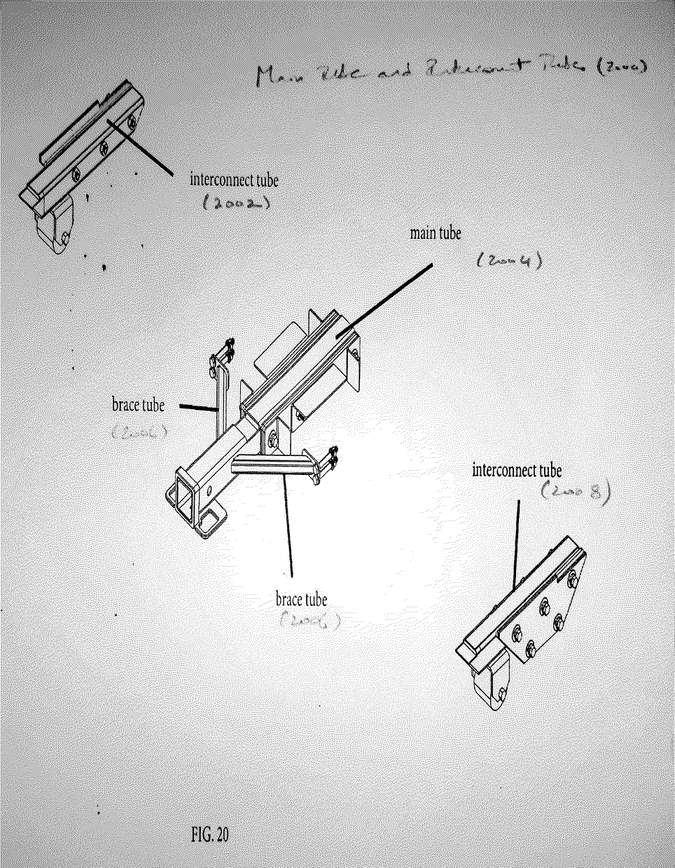

FIG. 20 is a diagram showing views of a main tube and an interconnect tube in accordance with some implementations. More specifically, FIG. 20 shows a first view 2002 and a second view 2008 of the interconnect tube and a single view 2004 of the main tube (which is also referred to herein as a hitch adapter tube), with the main tube including two brace tubes 2006.

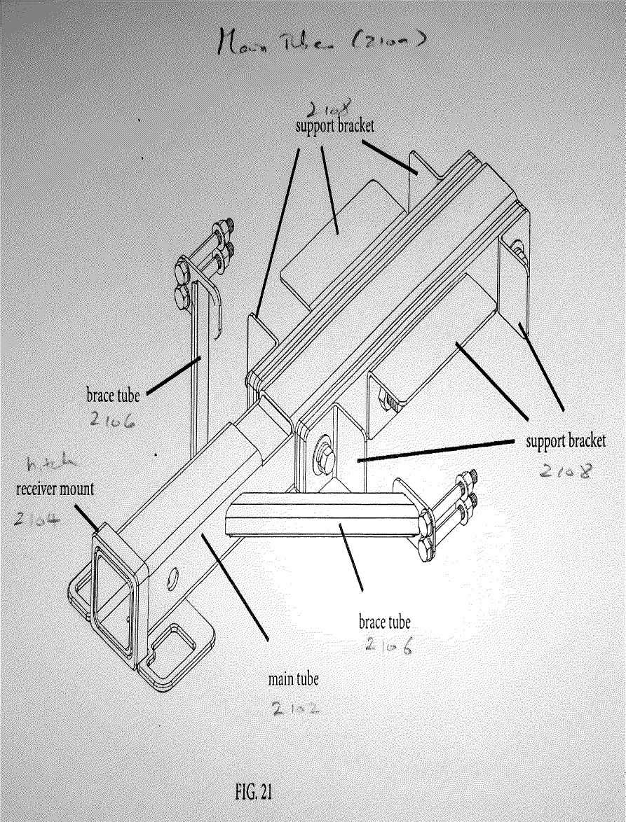

FIG. 21 is a diagram showing an isometric view of a main tube in accordance with some implementations. More specifically, FIG. 21 shows a view 2100 of the main tube 2102 (also referred to herein as a hitch adapter tube) that includes a hitch receiver mount 2104, two brace tubes 2106, and a plurality of support brackets 2108 (at least six are shown in the figure).

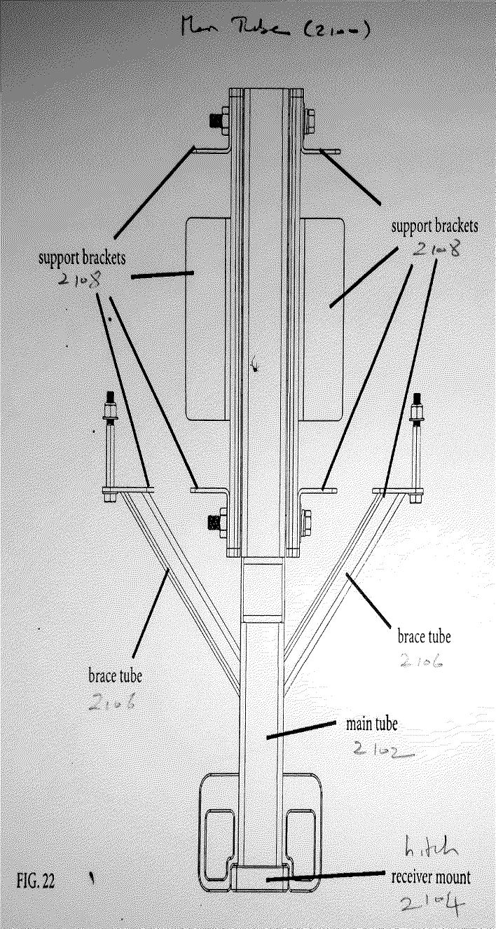

FIG. 22 is a diagram showing an isometric view of a main tube in accordance with some implementations. More specifically, FIG. 22 shows a view 2200 of the main tube 2102 (also referred to herein as a hitch adapter tube) that includes a hitch receiver mount 2104, two brace tubes 2106, and a plurality of support brackets 2108 (at least eight are shown in the figure).

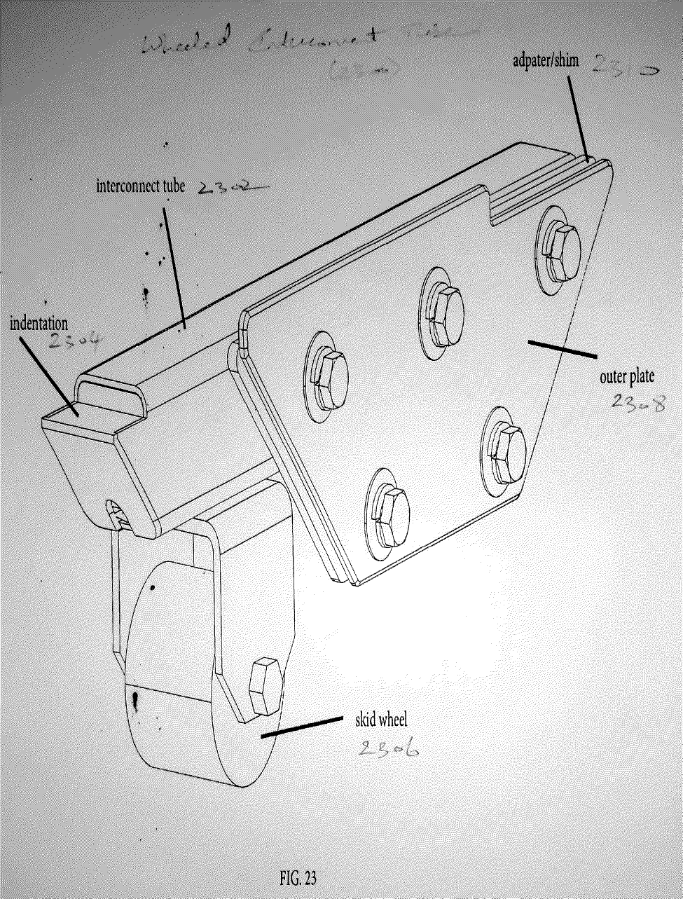

FIG. 23 is a diagram showing an isometric view of a wheeled interconnect tube in accordance with some implementations. More specifically, FIG. 23 shows an interconnect tube 2302, an indentation 2304 on the interconnect tube 2302, a skid wheel 2306, an outer plate 2308, and an adapter/shim 2310 that is bolted to the interconnect tube 2302 using the outer plate 2308.

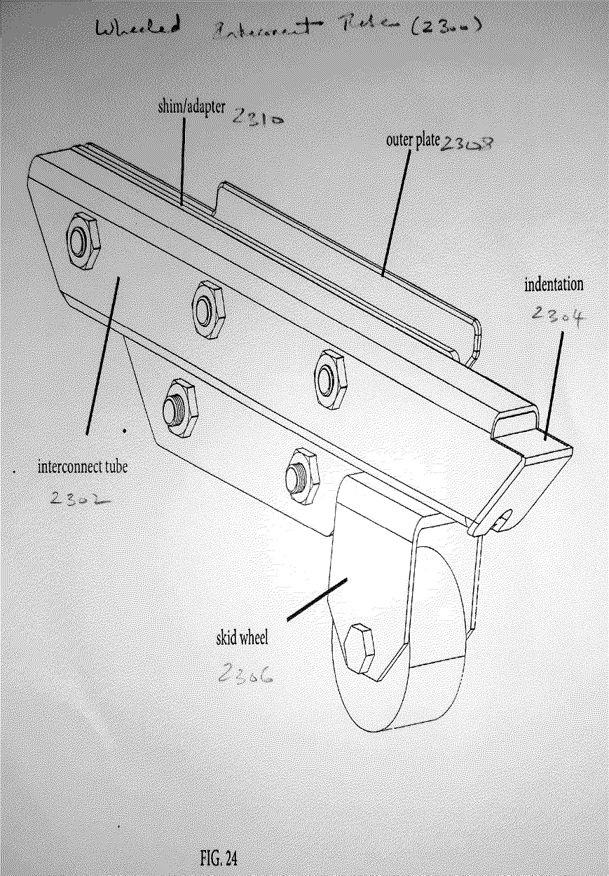

FIG. 24 is a diagram showing an isometric view of a wheeled interconnect tube in accordance with some implementations. More specifically, FIG. 24 shows an interconnect tube 2302, an indentation 2304 on the interconnect tube 2302, a skid wheel 2306, an outer plate 2308, and an adapter/shim 2310 that is bolted to the interconnect tube 2302 using the outer plate 2308.

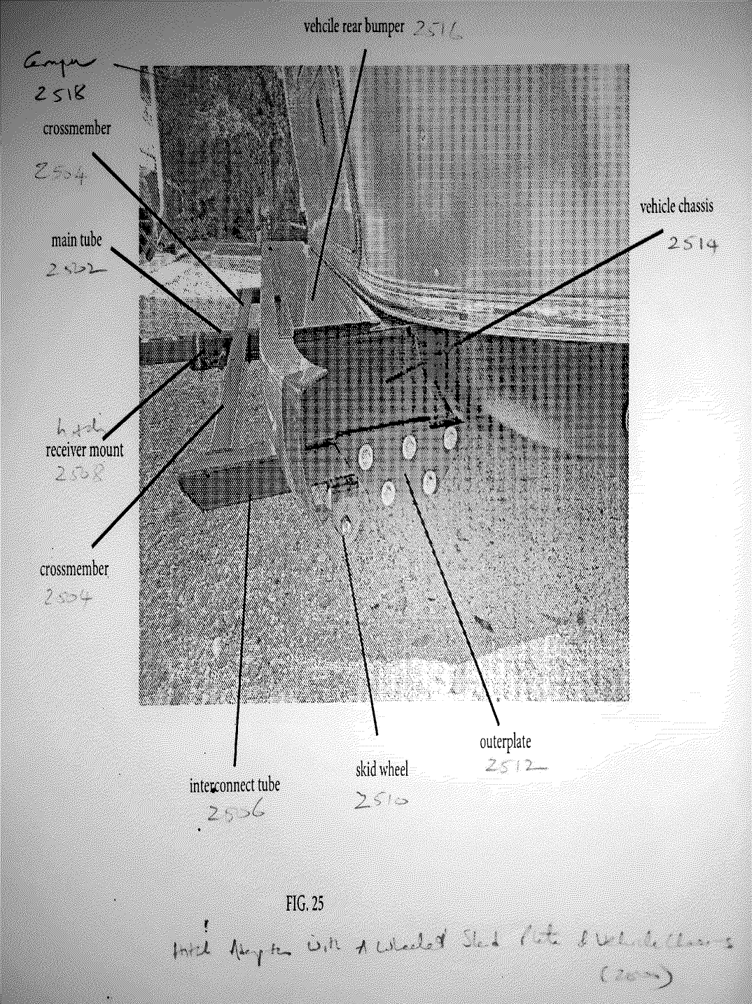

FIG. 25 is a diagram showing a hitch adapter with a wheeled skid plate attached to a vehicle chassis in accordance with some implementations. More specifically, FIG. 25 shows a main tube 2502, crossmember(s) 2504, an interconnect tube 2506, a hitch receiver mount 2508, a skid wheel 2510, an outer plate 2512, a vehicle chassis 2514, a vehicle rear bumper 2516, and a camper vehicle 2518 (to which the hitch adapter with the wheeled skid plate is attached to).

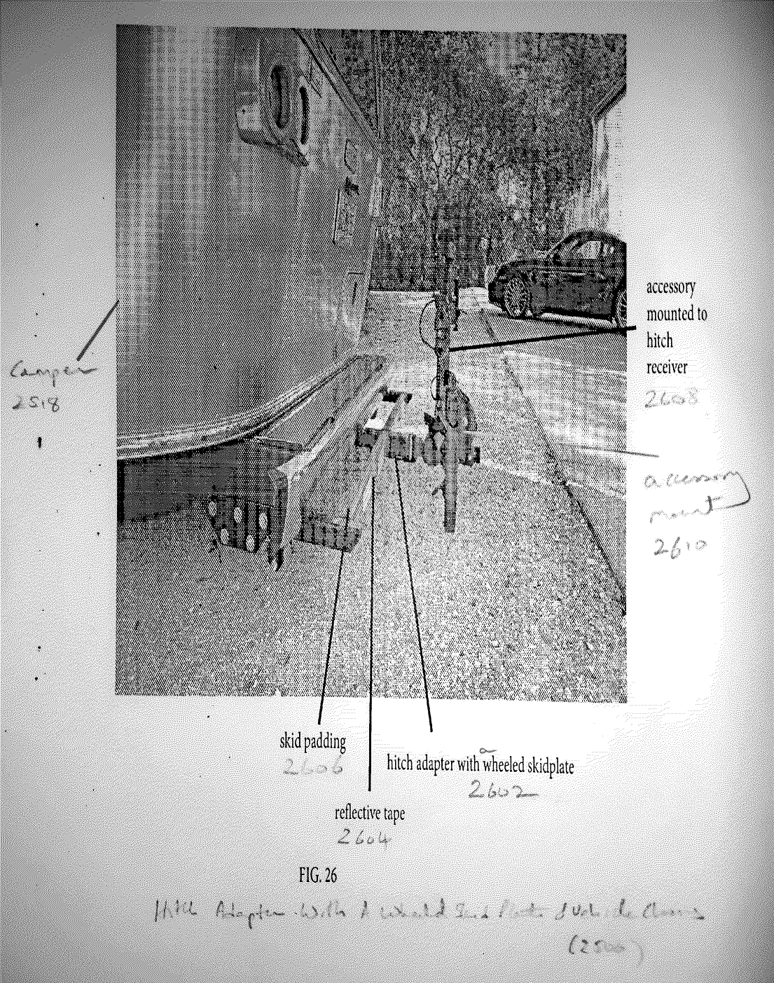

FIG. 26 is a diagram showing a hitch adapter with a wheeled skid plate attached to a vehicle chassis in accordance with some implementations. More specifically, FIG. 26 shows a hitch adapter with a wheeled skid plate 2602, reflective tape 2604 and anti-skid padding 2606 on components of the hitch adapter with a wheeled skid plate 2602, an accessory 2608 mounted onto a hitch receiver, an accessory mount 2610 through which the accessory 2608 is mounted onto the hitch receiver, and a camper vehicle 2518 (which is also shown in FIG. 25 above).

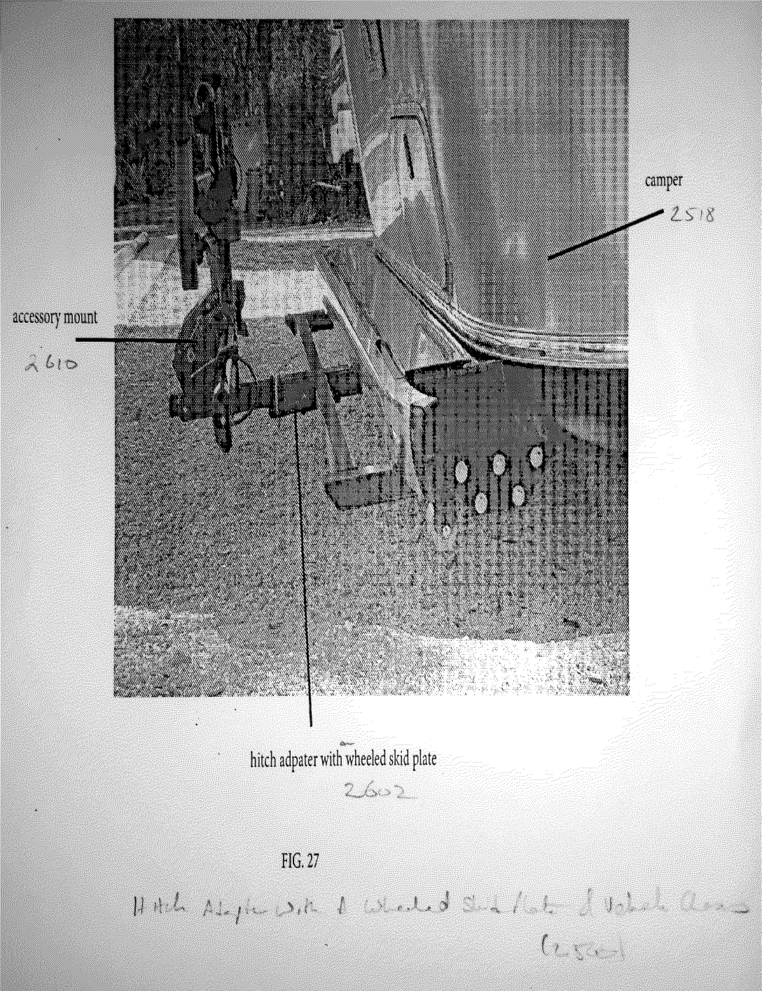

FIG. 27 is a diagram showing a hitch adapter with a wheeled skid plate attached to a vehicle chassis in accordance with some implementations. More specifically, FIG. 27 shows a hitch adapter with a wheeled skid plate 2602, an accessory mount 2610 (which is also shown in FIG. 26 above) to mount an accessory onto the hitch receiver, and a camper vehicle 2518, to which the hitch adapter with the wheeled skid plate is attached to as shown in the figure.

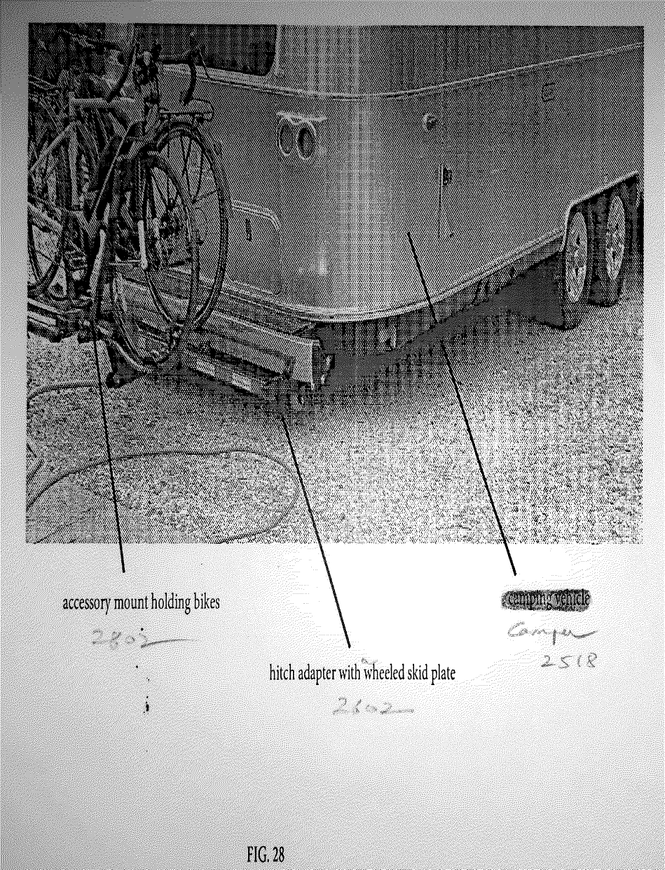

FIG. 28 is a diagram showing a hitch adapter with a wheeled skid plate attached to a vehicle chassis in accordance with some implementations. More specifically, FIG. 28 shows a hitch adapter with a wheeled skid plate 2602, an accessory mount holding bikes 2802, and a camper vehicle 2518, to which the hitch adapter with the wheeled skid plate is attached to.

In some implementations, one or more of the components of the hitch adapter with the wheeled skid plate are provided with anti-skid padding and/or reflective tape (e.g., in FIG. 26).

In some implementations, at least one or more interconnect tubes do not include indentations or cut-outs or apertures.

It will be appreciated that the hitch adapter described herein is for illustration purposes only and is not intended to be limiting. Other hitch adapters may be used depending on a contemplated implementation. In some implementations, the hitch adapter with a wheeled skid plate can be attached to any vehicle, equipment, or device that is appropriately sized to interface with the receiver mount attached to the hitch adapter.

A benefit of the disclosed hitch adapter with a wheeled skid plate is that the invention prevents vehicle chassis drag on steep surfaces by providing adequate rolling contact between the vehicle chassis and a steep surface and redistributing the contact force (corresponding to the contact of the vehicle chassis with the surface) via a weight and/or force distribution framework.

In some implementations, the hitch adapter tube, i.e., the main tube, is a standard 2″ (2 inch) square receiver mount. In some implementations, the hitch adapter with a wheeled skid plate can be made of one or more of steel, aluminum, or other metals, fiberglass, carbon, plastics or other polymers, rubber, a natural material, a synthetic material, or a composite material. The skid wheels can be selected from available stock skid wheels or from custom-made skid wheels.

It will be appreciated that any dimensions described herein are for illustration purposes only and are not intended to be limiting. Other dimensions could be used depending on a contemplated implementation.

Appendix A shows diagrams of an example long mount hitch version.

The long mount version extends beyond the rear bumper of the Airstream (or other trailer). In this version, the rearward tube on the hitch is exposed to be used either as (a) a step or (b) a horizontal tube with vertical ½-13 threaded holes for mounting brackets for scuba tanks, an outdoor washer, outdoor barbeque or alike items one may wish to store outside.

The hitch can also be welded into three unique sub-assemblies: a right sub-assembly, a left sub-assembly, and the middle-hitch-tube sub-assembly for the mounting of a bike rack, transport rack or the like.

Shims can be used on both the right and left sides of the middle-hitch-tube-sub-assembly to adjust for the width and tolerance/clearance variations between trailers.

Appendix B shows diagrams of an example short mount version.

The short mount hitch version extends beyond the rear bumper of the Airstream or other trailer. In this version, the rearward tube on the hitch is exposed to be used either as (a) a step or (b) a horizontal tube with vertical ½-13 threaded holes for mounting brackets for scuba tanks, an outdoor washer, outdoor barbeque, or alike items one may wish to store outside.

Some implementations can be welded into three unique sub-assemblies; a right sub-assembly, a left sub-assembly. and the middle-hitch-tube sub-assembly for the mounting of a bike rack, transport rack or the like.

Shims can be used on both the right and left sides of the middle-hitch-tube-sub-assembly, to adjust for the width and tolerance/clearance variations between trailers.

It will be appreciated that although the example implementations have been described in terms of mounting on an Airstream™ trailer, a hitch adapter with a wheeled skid plate can be configured for other trailers. The disclosed hitches were primarily designed for Airstream™ Travel Trailers, but implementations of the hitches are in no way limited to configurations for Airstream™ trailers alone. Implementations can be manufactured from welded or appropriately joined, screwed or bonded aluminum, steel, composites, other/sheet-metal or any other suitable material. An important feature of some implementations of the hitch adapter with a wheeled skid plate is that it only attaches to the frame of the trailer and does not require any connection to the trailer shell.

It is therefore apparent that there is provided, in accordance with the various example implementations disclosed herein, a hitch adapter with a wheeled skid plate. The hitch adapter with a wheeled skid plate can improve vehicle weight and/or force distribution via an improved weight and/or force distribution framework and by providing a rolling point of contact between the vehicle chassis and the surface that the vehicle makes contact with in some implementations.

While the disclosed subject matter has been described in conjunction with a number of implementations, it is evident that many alternatives, modifications and variations would be or are apparent to those of ordinary skill in the applicable arts. Accordingly, the Applicant intends to embrace all such alternatives, modifications, equivalents, substitutes, and variations that are within the spirit and scope of the disclosed subject matter.

What is claimed is:

1. A hitch adapter comprising:
a hitch adapter tube, wherein the hitch adapter tube is attached to the hitch adapter;
one or more crossmember tubes, wherein the one or more crossmember tubes extend from the hitch adapter tube;
one or more interconnect tubes, wherein one or more of the one or more interconnect tubes connect one or more of the one or more crossmember tubes; and
a skid wheel, wherein the skid wheel is attached to at least one of the one or more interconnect tubes.

2. The hitch adapter of claim 1, wherein the hitch adapter tube comprises a proximal end and a distal end.

3. The hitch adapter of claim 1, wherein the hitch adapter tube is a 2-inch square receiver mount.

4. The hitch adapter of claim 1, wherein the one or more interconnect tubes comprise a left interconnect tube and a right interconnect tube.

5. The hitch adapter of claim 4, wherein the left interconnect tube is towards left of the proximal end of the hitch adapter tube.

6. The hitch adapter of claim 4, wherein the right interconnect tube is towards right of the proximal end of the hitch adapter tube.

7. The hitch adapter of claim 1, wherein the hitch adapter is made of one or more of steel, aluminum, fiberglass, carbon, rubber, polymer, plastic, a natural material, a synthetic material, or a composite material.

8. The hitch adapter of claim 1, wherein the skid wheel is attached below the at least one of the one or more interconnect tubes.

9. The hitch adapter of claim 1, wherein the hitch adapter tube, at least one of the one or more crossmember tubes, and at least one of the one or more interconnect tubes form a skid plate.

10. The hitch adapter of claim 9, wherein the skid plate has at least one of a polygonal shape, a circular shape, or an oval shape.

11. The hitch adapter of claim 1, wherein the hitch adapter tube, at least one of the one or more crossmember tubes, and at least one of the one or more interconnect tubes comprise one or more of one or more indentations, one or more cutouts, or one or more apertures.

12. The hitch adapter of claim 1, wherein the hitch adapter tube and at least one of the one or more crossmember tubes are connected using one or more support brackets.

13. The hitch adapter of claim 1, wherein at least one of the one or more crossmember tubes and at least one of the one or more interconnect tubes are connected through one or more support brackets.

14. The hitch adapter of claim 1, wherein at least one of the hitch adapter tubes, at least one of the one or more crossmember tubes, and at least one of the one or more interconnect tubes are attached to one or more end-caps.

15. A hitch adapter comprising:
a hitch adapter tube, wherein the hitch adapter tube is attached to the hitch adapter, and wherein the hitch adapter tube comprises a proximal end and a distal end;
a first brace tube and a second brace tube, wherein the first brace tube and the second brace tube are each attached to the proximal end and one of the one or more crossmember tubes;
one or more crossmember tubes, wherein the one or more crossmember tubes extend from the hitch adapter tube;
one or more interconnect tubes, wherein one or more of the one or more interconnect tubes connect one or more of the one or more crossmember tubes; and
a skid wheel, wherein the skid wheel is attached to at least one of the one or more interconnect tubes.

16. The hitch adapter of claim 15, wherein the first brace tube and the second brace tube are bolted to the hitch adapter tube.

17. The hitch adapter of claim 15, wherein the first brace tube and the second brace tube are welded to the hitch adapter tube.

18. The hitch adapter of claim 15, wherein the hitch adapter is made of one or more of steel, aluminum, fiberglass, carbon, rubber, polymer, plastic, a natural material, a synthetic material, or a composite material.

19. The hitch adapter of claim 15, wherein the skid wheel is attached below the at least one of the one or more interconnect tubes.

20. The hitch adapter of claim 15, wherein the hitch adapter tube is a 2-inch square receiver mount.
